(19) United States
(12) Patent Application Publication
(10) Pub. No.: US 2024/0317200 A1
(43) Pub. Date: Sep. 26, 2024

(54) FAIL-SAFE REDUNDANT BRAKE SYSTEM WITH A PRESSURE SUPPLY VIA A VENTILATION PATH OF THE PRIMARY MODULATOR

(71) Applicant: ZF CV Systems Global GmbH, Bern (CH)

(72) Inventor: Julian van Thiel, Grossburgwedel (DE)

(21) Appl. No.: 18/679,090

(22) Filed: May 30, 2024

Related U.S. Application Data
(63) Continuation of application No. PCT/EP2022/080473, filed on Nov. 2, 2022.

(30) Foreign Application Priority Data
Nov. 30, 2021 (DE) 10 2021 131 327.9

(51) Int. Cl. B60T 13/68; B60T 13/66

(52) U.S. Cl. CPC B60T 13/683; B60T 13/662; B60T 13/665

(57) ABSTRACT

An electronically controllable pneumatic brake system for a utility vehicle has an electronic service brake control unit and a brake pressure modulator which modulates a service brake pressure at a service brake pressure port in accordance with service braking signals provided by the electronic service brake control unit. The brake pressure modulator has a ventilation port. The brake system furthermore has an electronic redundancy control unit and at least one redundancy pressure modulator which modulates a redundancy brake pressure at a redundancy brake pressure port in accordance with redundancy braking signals that are provided by the electronic redundancy control unit. The redundancy pressure modulator has a redundancy ventilation port. Provision is made for the redundancy brake pressure port to be connected to the ventilation port such that the redundancy brake pressure can be modulated, via a ventilation path of the brake pressure modulator, at the service brake pressure port.

### CROSS-REFERENCE TO RELATED APPLICATIONS

This application is a continuation application of international patent application PCT/EP2022/080473, filed Nov. 2, 2022, designating the United States and claiming priority from German application 10 2021 131 327.9, filed Nov. 30, 2021, and the entire content of both applications is incorporated herein by reference.

### TECHNICAL FIELD

The disclosure relates to an electronically controllable pneumatic brake system for a vehicle, preferably utility vehicle, having an electronic service brake (normal brake) control unit and having at least one first brake pressure modulator which is connected to a first compressed-air reservoir in order to receive reservoir pressure and which modulates a first service brake (normal brake) pressure at least at one first service brake (normal brake) pressure port (14) in accordance with first service braking (normal braking) signals that are provided by the electronic service brake (normal brake) control unit. The first brake pressure modulator has a first ventilation port for venting the first service brake (normal brake) pressure. The brake system furthermore has an electronic redundancy control unit and at least one first redundancy pressure modulator which is connected to the first compressed-air reservoir or to a further compressed-air reservoir in order to receive reservoir pressure and which modulates a first redundancy brake pressure at least at one first redundancy brake pressure port in accordance with first redundancy braking signals that are provided by the electronic redundancy control unit. The first redundancy pressure modulator has a first redundancy ventilation port for venting the first redundancy brake pressure.

### BACKGROUND

Concepts for redundantly modulating a brake pressure generally use, in part, redundant components and, in part, existing components in order to modulate the brake pressure. For example, US 2019/0152459 has disclosed a system in which, in the event of failure of a central control unit that would otherwise electronically actuate a front axle modulator, a bypass valve pneumatically modulates a redundancy pressure, which is then provided to the front axle modulator in order to thus achieve redundant pneumatic modulation of the front axle brake pressure. US 2019/0152459 generally discloses an electronically controllable pneumatic brake system having at least two brake circuits, wherein at least one of the at least two brake circuits is assigned an electrically and pneumatically controllable control valve, and a further one of the at least two brake circuits is assigned an electrically controllable parking brake valve, for the purposes of specifying brake pressures for actuating wheel brakes of the particular brake circuit. A first control unit is provided, which is configured to electrically actuate the particular control valve in accordance with a vehicle setpoint deceleration, which is demanded in automated fashion, or in accordance with an actuation of a brake pedal by the driver. Furthermore, in order to provide electronically and pneumatically controlled redundancy, a second control unit is provided which is configured to electrically control the parking brake valve in accordance with the vehicle setpoint deceleration, which is demanded in automated fashion, if an electrical actuation of the particular control valve is prevented. Furthermore, a bypass valve is provided which is assigned to one of the control valves and which is configured to pneumatically actuate the assigned control valve, wherein the pneumatic control is performed in accordance with the vehicle setpoint deceleration, which is demanded in automated fashion, or in accordance with the actuation of the brake pedal by the driver, if an electrical actuation of the particular control valve is prevented.

Such a configuration however requires that the corresponding redundancy port of the control valve, specifically of the front axle modulator or rear axle modulator, is functional. Such a solution is therefore dependent on a main actuator system of the control valve, specifically front axle modulator or rear axle modulator, being functional.

There are also other approaches for establishing a fully redundant brake system, as disclosed in particular in US 2022/0144232. According to the teaching of the document, all relevant system elements are duplicated, and a fully redundant brake system is thus established. The brake systems are then combined via select-high valves at the brake actuators. This solution however has the disadvantage from a flow aspect that even the primary system can modulate the brake pressure to the brake actuators only via the select-high valves, and therefore not directly. The duplication of all of the individual components furthermore results in an increased installation space requirement.

### SUMMARY

It is therefore an object of the present disclosure to further improve the existing systems, which function well in principle, and to achieve high availability while at the same time providing solutions which are advantageous from a flow aspect and which have less of a retroactive effect, or no retroactive effect, on the primary system.

The disclosure, for example, achieves the object, in the case of an electronically controllable pneumatic brake system of the type mentioned in the introduction, in that the first redundancy brake pressure port of the redundancy pressure modulator is connected to the first ventilation port of the first brake pressure modulator such that the first redundancy brake pressure can be modulated, via a first ventilation path of the first brake pressure modulator, at the first service brake (normal brake) pressure port of the first brake pressure modulator.

The disclosure is based on the recognition that the ventilation path of a modulator is available even in the event of a severe fault. By contrast to a redundancy port of a modulator that is reliant upon the availability of a main actuator system of the modulator, for example because a control pressure that is modulated at the redundancy port firstly acts on a control surface of a relay valve in order to boost the volume of the control pressure, modulation of the brake pressure via the ventilation path does not require such an actuator system, and can generally be used even in the case of a faulty relay valve. By contrast to the conventional case of a redundancy port, provision is made according to the disclosure whereby the first redundancy pressure modulator modulates a first redundancy brake pressure, specifically a volume pressure, not merely a control pressure that still needs to be boosted in volume.

According to the disclosure, the redundancy brake pressure is passed through the ventilation path of the first brake pressure modulator and is provided, preferably without modulation, at the first service brake (normal brake) pressure port. Furthermore, no select-high valve is necessary in order to feed the redundancy brake pressure and service brake (normal brake) pressure alternately, or as required, to the brake actuator. A structural simplification of the solution known from the prior art is thus achieved, while at the same time increasing stability and availability and optimizing the flow situation. The first brake pressure modulator may for example be provided for a front axle, and thus be referred to as a front axle modulator. It may likewise be provided for a rear axle, and referred to as a rear axle modulator. The first service brake (normal brake) pressure would then be, in the former case, a front axle service brake (normal brake) pressure and, in the latter case, a rear axle service brake (normal brake) pressure. Provision may also be made for the first brake pressure modulator to be provided not for an axle but for one side of the vehicle, for example the left-hand side, or in a crosswise configuration, for example for a left-hand front wheel and a right-hand rear wheel. It should furthermore be understood that the electronically controllable pneumatic brake system may have two or more brake pressure modulators, and correspondingly two or more redundancy pressure modulators. Provision may also be made whereby one, two or more service brake (normal brake) actuators are connected to the first service brake (normal brake) pressure port, optionally via one or more ABS valves. The first brake pressure modulator may be configured to allow wheel-specific modulation of brake pressures, and preferably of slip-controlled brake pressures. Provision may however also be made to allow only axle-specific modulation of the service brake (normal brake) pressure, and in this respect the provision of additional and/or separate ABS valves may be expedient.

In a first embodiment, the first brake pressure modulator has a first rapid ventilation valve at the first ventilation port for the purposes of venting the first service brake (normal brake) pressure. The rapid ventilation valve may be integrated into the brake pressure modulator or externally flange-mounted separately therefrom, for example on a housing of the first brake pressure modulator. It is also conceivable for the first rapid ventilation valve to be installed as an independent structural unit. Via the rapid ventilation valve, the first service brake (normal brake) pressure can be rapidly and directly vented, and it is not necessary for the first service brake (normal brake) pressure to be vented for example via a central vent of a relay piston in the first brake pressure modulator. A noise suppressor may furthermore be connected to the first rapid ventilation valve.

The first rapid ventilation valve preferably has a first rapid ventilation valve port, which is connected to the first ventilation path, a second rapid ventilation valve port, which is connected to the surroundings, and a third rapid ventilation valve port, which is connected to the first redundancy brake pressure port. The second rapid ventilation valve port that is connected to the surroundings may also lead to a central vent. In this way, via the ventilation path, it is firstly possible for the first service brake (normal brake) pressure to be vented as required if it is sought to dissipate the brake pressure in the service brake (normal brake) cylinder, and it is secondly also possible for the first redundancy brake pressure to be fed in, specifically via the third rapid ventilation valve port, which is connected to the first redundancy brake pressure port. The rapid ventilation valve is preferably formed such that, when the brake system is in an operational state, in which the first redundancy pressure modulator is not active, the first rapid ventilation valve port has an open connection to the second rapid ventilation valve port. For example, a valve element which is preloaded toward the third rapid ventilation valve port may be provided in order to initially shut off same and provide an unobstructed ventilation path from the first to the second rapid ventilation valve port.

In a further embodiment, provision is made whereby the first brake pressure modulator has a first service brake (normal brake) relay valve, the first service brake (normal brake) relay valve having a first service brake (normal brake) relay valve reservoir port, which is connected to a first reservoir port, a first service brake (normal brake) relay valve working port, which is connected to the first service brake (normal brake) pressure port, a first service brake (normal brake) relay valve control port, which receives a first pilot control pressure, and a first service brake (normal brake) relay valve ventilation port, which forms or is connected to the first ventilation port. In the normal situation, the first service brake (normal brake) relay valve serves to boost the volume of the received first pilot control pressure and modulate the latter as a first service brake (normal brake) pressure. If no pilot control pressure is provided, and if ambient pressure prevails at the first service brake (normal brake) relay valve control port, the first service brake (normal brake) relay valve ventilation port is connected to the first service brake (normal brake) relay valve working port. This path may then be used to pass the first redundancy brake pressure through and provide same at the first service brake (normal brake) pressure port. The first service brake (normal brake) relay valve does not imperatively need to be functional for this purpose. It is sufficient for the ventilation path of the service brake (normal brake) relay valve to be available and to be usable for modulating the first redundancy brake pressure. In this way, the availability of the electronically controllable pneumatic brake system can be increased, even for the situation in which the first service brake (normal brake) relay valve is non-functional or is not functioning correctly.

In a embodiment, the first service brake (normal brake) relay valve ventilation port is connected to the first rapid ventilation valve port. The rapid ventilation valve may be directly integrated into the first brake pressure modulator, such that it may also be structurally integrated with the first service brake (normal brake) relay valve.

In a further embodiment, the electronically controllable pneumatic brake system includes a second brake pressure modulator which is connected to a second compressed-air reservoir in order to receive reservoir pressure and which modulates at least one second service brake (normal brake) pressure at least at one second service brake (normal brake) pressure port in accordance with second service braking (normal braking) signals that are provided by the electronic service brake (normal brake) control unit. The second brake pressure modulator preferably has a second ventilation port for venting the second service brake (normal brake) pressure. The electronically controllable pneumatic brake system furthermore preferably includes a second redundancy pressure modulator which is connected to the second compressed-air reservoir or to a further compressed-air reservoir in order to receive reservoir pressure and which modulates a second redundancy brake pressure at least at one second redundancy brake pressure port in accordance with second redundancy braking signals that are provided by the electronic redundancy control unit.

The second redundancy pressure modulator preferably has a second redundancy ventilation port for venting the second redundancy brake pressure. The second redundancy brake pressure port is preferably connected to the second ventilation port such that the second redundancy brake pressure can be modulated, via a second ventilation path of the second brake pressure modulator, at the second service brake (normal brake) pressure port. The described embodiment accordingly includes a duplication of the brake pressure modulators and redundancy pressure modulators in order to thus be able to brake two axles, two wheels, two sides, or the like, of the vehicle independently of one another. If the first brake pressure modulator is a front axle modulator, then the second brake pressure modulator is preferably a rear axle modulator. The first and the second brake pressure modulator may be identical or may differ. For example, the first brake pressure modulator may be configured as a single-channel modulator while the second brake pressure modulator is configured as a two-channel modulator, or vice versa. It is also possible for both to be configured as a single-channel modulator or for both to be configured as a two-channel modulator. The same also applies to the first and the second redundancy pressure modulator. The first redundancy pressure modulator may be configured as a single-channel modulator, and the second redundancy pressure modulator may be configured as a two-channel modulator, or vice versa. It is also possible for both redundancy pressure modulators to be configured as a single-channel modulator or as a two-channel modulator. This is true irrespective of the embodiment of the first and of the second brake pressure modulator. Any conceivable pairing is preferred here. Like the first redundancy pressure modulator, the second redundancy pressure modulator may also be connected to the second compressed-air reservoir or to a further compressed-air reservoir. The further compressed-air reservoir is preferably independent of the second compressed-air reservoir in order to thus enable redundant braking even in the event of failure of the second compressed-air reservoir. The second compressed-air reservoir is assigned to the primary system, while the further compressed-air reservoir may be assigned to the redundancy level. The further compressed-air reservoir that provides a supply to the second redundancy pressure modulator may be the same further reservoir that also provides a supply to the first redundancy pressure modulator. It is also preferable for the first and the second redundancy pressure modulator to have dedicated further compressed-air reservoirs in order to thus further develop the independence from the primary system.

The second brake pressure modulator preferably has a second rapid ventilation valve at the second ventilation port for the purposes of venting the second service brake (normal brake) pressure. The statements made above regarding the first rapid ventilation valve apply analogously to the second rapid ventilation valve. The second rapid ventilation valve may also be integrated into the second brake pressure modulator or flange-mounted onto a housing of the second brake pressure modulator or installed as a separate element in the brake system.

It can furthermore be preferred that the second rapid ventilation valve has a fourth rapid ventilation valve port, which is connected to the second ventilation path, a fifth rapid ventilation valve port, which is connected to the surroundings, and a sixth rapid ventilation valve port, which is connected to the second redundancy brake pressure port. Here, too, the statements made above regarding the first rapid ventilation valve apply, such that, for the advantages and embodiments of the second rapid ventilation valve, reference is made to those of the first rapid ventilation valve.

Similarly to the first brake pressure modulator, the second brake pressure modulator may also have a second service brake (normal brake) relay valve, the second service brake (normal brake) relay valve having a second service brake (normal brake) relay valve reservoir port, which is connected to a second reservoir port, a second service brake (normal brake) relay valve working port, which is connected to the second service brake (normal brake) pressure port, a service brake (normal brake) relay valve control port, which receives a second pilot control pressure, and a second service brake (normal brake) relay valve ventilation port, which forms or is connected to the second ventilation port. The second service brake (normal brake) relay valve ventilation port may be connected to the fourth rapid ventilation valve port.

In a further embodiment, provision is made whereby the second brake pressure modulator modulates a third service brake (normal brake) pressure at least at one third service brake (normal brake) pressure port in accordance with third service braking (normal braking) signals that are provided by the electronic service brake (normal brake) control unit, wherein the second brake pressure modulator has a third ventilation port for venting the third service brake (normal brake) pressure. The second redundancy pressure modulator modulates a third redundancy brake pressure at least at one third redundancy brake pressure port in accordance with third redundancy braking signals that are provided by the electronic redundancy control unit. The second redundancy ventilation port acts so as to vent the third redundancy brake pressure, and the third redundancy brake pressure port is connected to the third ventilation port, such that the third redundancy brake pressure can be modulated, via a third ventilation path of the second brake pressure modulator, at the third service brake (normal brake) pressure port. In this embodiment, both the second brake pressure modulator and the second redundancy pressure modulator are of two-channel configuration, such that, in each case, the second and third redundancy brake pressure ports are connected to second and third ventilation ports in order to introduce the second and third redundancy brake pressures via second and third ventilation paths of the second brake pressure modulator. Such a configuration is expedient in particular if it is intended to modulate a brake pressure on a side-specific basis using only one modulator.

In such an embodiment, the second brake pressure modulator preferably includes a third rapid ventilation valve at the third ventilation port for the purposes of venting the third service brake (normal brake) pressure. Preferably, the third rapid ventilation valve has a seventh rapid ventilation valve port, which is connected to the third ventilation path, an eighth rapid ventilation valve port, which is connected to the surroundings, and a ninth rapid ventilation valve port, which is connected to the third redundancy brake pressure port. In this respect, the third rapid ventilation valve corresponds in terms of its configuration to the first and the second rapid ventilation valve, and, for the further advantages and embodiments, reference is made to the description above relating to the first rapid ventilation valve. These statements apply here analogously.

Provision may also be made whereby the second brake pressure modulator has a third service brake (normal brake) relay valve, the third service brake (normal brake) relay valve having a third service brake (normal brake) relay valve reservoir port, which is connected to the second reservoir port, a third service brake (normal brake) relay valve working port, which is connected to the third service brake (normal brake) pressure port, a third service brake (normal brake) relay valve control port, which receives a third pilot control pressure, and a third service brake (normal brake) relay valve ventilation port, which forms or is connected to the third ventilation port. The third service brake (normal brake) relay valve is accordingly provided for the second channel of the second brake pressure modulator, which is thus of two-channel configuration. Each channel of the two-channel second brake pressure modulator has a dedicated service brake (normal brake) relay valve with a dedicated ventilation port. It is also preferable, as has likewise been discussed in the preceding embodiments, for the third service brake (normal brake) relay valve ventilation port to be connected to the seventh rapid ventilation valve port. In this way, the third redundancy brake pressure can be fed to the third service brake (normal brake) relay valve ventilation port, and the third service brake (normal brake) relay valve ventilation port can be ventilated.

In a further embodiment of the electronically controllable pneumatic brake system, this has a trailer control valve having at least one trailer brake pressure port, for providing a trailer brake pressure for a trailer, a trailer reservoir port, for receiving reservoir pressure, and a trailer ventilation port, for venting the trailer brake pressure. The trailer control valve is preferably connected to the electronic service brake (normal brake) control unit and receives trailer braking signals therefrom, and modulates the trailer brake pressure preferably on the basis of the trailer braking signals. A trailer that is optionally connected to the vehicle can be braked via the trailer control valve. For this purpose, the trailer control valve preferably has one or more electrically switchable solenoid valves. The trailer control valve may furthermore have a trailer relay valve in order to boost the volume of a pilot control pressure that is modulated by electrically switchable solenoid valves and to provide the pilot control pressure to the trailer. The exact configuration of the trailer control valve may differ depending on whether the electronically controllable pneumatic brake system is configured for the European or North American market. The trailer control valve described herein is intended to encompass both variants.

In an embodiment, the first redundancy pressure modulator or the second redundancy pressure modulator has a trailer redundancy brake pressure port for providing a trailer redundancy pressure. A trailer control valve is typically actuated redundantly via pressures from a front axle of the vehicle, such that, if the first redundancy pressure modulator is provided for the front axle of the vehicle, it is the first redundancy pressure modulator that has the trailer redundancy brake pressure port for providing the trailer redundancy pressure. It is however alternatively also possible for the second redundancy pressure modulator, which in the situation described is then preferably provided for the rear axle, to be that which has the trailer redundancy brake pressure port for providing the trailer redundancy pressure. The trailer redundancy pressure may in principle be modulated at a redundancy port of the trailer control valve in the conventional manner that is known from the prior art. It is however particularly preferable for the trailer redundancy brake pressure port to be connected to the trailer ventilation port such that the trailer redundancy pressure can be modulated, via a trailer ventilation path of the trailer control valve, at the trailer brake pressure port. The same considerations as those set out above with regard to the first brake pressure modulator and the second brake pressure modulator, specifically the fact that a ventilation path thereof is used for modulating the redundancy brake pressure, is now applied here to the trailer control valve. In the case of the trailer control valve, too, the trailer ventilation path is used for the introduction of the trailer redundancy pressure.

The trailer redundancy pressure may correspond to the first redundancy pressure, to the second redundancy pressure and/or to the third redundancy pressure.

Even if the first redundancy pressure modulator has the trailer redundancy brake pressure port, this does not necessarily mean that the first redundancy pressure modulator may be configured as a two-channel modulator. Rather, the first redundancy pressure modulator may be configured as before as a single-channel modulator, and the trailer redundancy brake pressure corresponds to the first redundancy brake pressure, such that the first redundancy brake pressure port and the trailer redundancy brake pressure port are connected to the corresponding valve for example via a Y-shaped line.

In an embodiment, the electronic service brake (normal brake) control unit is connected to a first voltage source and the electronic redundancy control unit is connected to a second voltage source. The first and second voltage sources are preferably independent of one another, such that a fault in one voltage source cannot lead to a failure of the other voltage source. The availability of the electronically controllable pneumatic brake system can thus be further increased.

Provision is preferably likewise made for the first compressed-air reservoir and the further compressed-air reservoir to be independent of one another. Preferably, a supply is provided to the first compressed-air reservoir and to the further compressed-air reservoir by two different and mutually independent compressed-air sources, in particular two compressed-air supplies. For example, a dedicated air preparation unit may be provided both for the first compressed-air reservoir and for the further compressed-air reservoir. Alternatively, the first compressed-air reservoir and the further compressed-air reservoir are connected to a common compressed-air preparation means but are pneumatically separated by a multi-circuit protection valve. The same preferably applies to the second compressed-air reservoir and the further compressed-air reservoir. Altogether, four compressed-air reservoirs may be provided; for example, the first compressed-air reservoir for the first brake pressure modulator, the further compressed-air reservoir for the first redundancy pressure modulator, the second compressed-air reservoir for the second brake pressure modulator, and a second further compressed-air reservoir for the second redundancy pressure modulator. Furthermore, a dedicated compressed-air reservoir may be provided for each further brake pressure modulator, and a further dedicated compressed-air reservoir may be provided for each further redundancy pressure modulator, with the statements made above being applicable to these reservoirs. Here, the compressed-air reservoirs provided for the redundancy pressure modulators are preferably each independent of the compressed-air reservoirs provided for the brake pressure modulators. Provision may be made whereby the compressed-air reservoirs for the brake pressure modulators are not independent of one another, and the further compressed-air reservoirs for the redundancy pressure modulators are not independent of one another, but all of the further compressed-air reservoirs provided for the redundancy pressure modulators are independent of the compressed-air reservoirs provided for the brake pressure modulators.

In a further embodiment, the electronically controllable pneumatic brake system has a unit for autonomous driving and a vehicle bus, wherein the electronic service brake (normal brake) control unit and the electronic redundancy control unit are connected to the unit for autonomous driving, and receive braking demand signals therefrom, via the vehicle bus or an alternative network communication means. The electronic service brake (normal brake) control unit and the electronic redundancy control unit are then preferably capable of converting the electronic braking demand signals and correspondingly actuating the one or more brake pressure modulators and the one or more redundancy pressure modulators. Alternative network communication means may for example include a direct wired connection, a CAN bus or other systems. In principle, wireless communication may also be used.

In a further aspect, the disclosure achieves the object stated in the introduction via a vehicle, preferably utility vehicle, having a front axle, at least one rear axle and an electronically controllable pneumatic brake system according to any one of the above-described embodiments of an electronically controllable pneumatic brake system according to the first aspect of the disclosure. It is to be understood that the electronically controllable pneumatic brake system according to the first aspect of the disclosure and the vehicle according to the second aspect of the disclosure have identical and similar sub-aspects. In this respect, reference is made to the above description in its entirety.

Preferably, the first brake pressure modulator is assigned to the front axle of the vehicle and the second brake pressure modulator is assigned to the at least one rear axle of the vehicle. The second brake pressure modulator may also be assigned the first and to the second rear axle of the vehicle. The first brake pressure modulator is preferably configured as a single-channel modulator, and the second brake pressure modulator is preferably configured as a two-channel modulator, which allows modulation of brake pressures on a side-specific basis.

### BRIEF DESCRIPTION OF DRAWINGS

The invention will now be described with reference to the drawings wherein:

FIG. 1 is a schematic illustration of an electronically controllable pneumatic brake system according to a first embodiment;

FIG. 2 is an illustration of a first brake pressure modulator;

FIG. 3 shows the first brake pressure modulator in interaction with a first redundancy pressure modulator;

FIG. 4 shows a second brake pressure modulator;

FIG. 5 shows the second brake pressure modulator in interaction with the second redundancy pressure modulator; and,

FIG. 6 shows a trailer control module.

### DETAILED DESCRIPTION

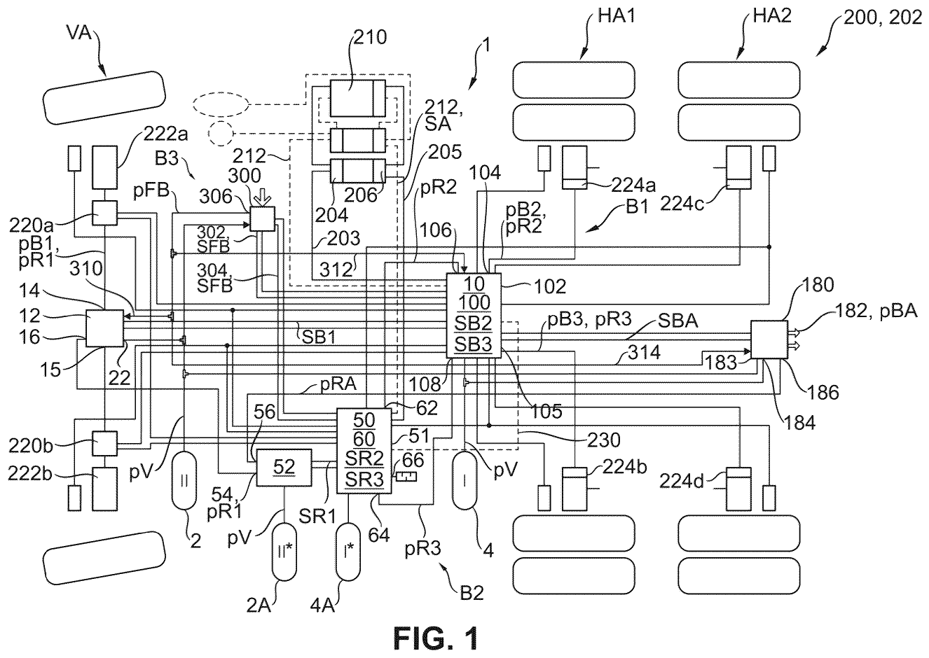

FIG. 1 illustrates a vehicle 200, specifically in particular a utility vehicle 202, having a first axle, which in this case is a front axle VA, a second axle, which in this case is a first rear axle HA1, and a third axle, which in this case is a second rear axle HA2. The vehicle 200 includes an electronically controllable pneumatic brake system 1, which includes a primary level B1 and a secondary level B2. The electronically controllable pneumatic brake system furthermore includes a manual level B3, as will be described below.

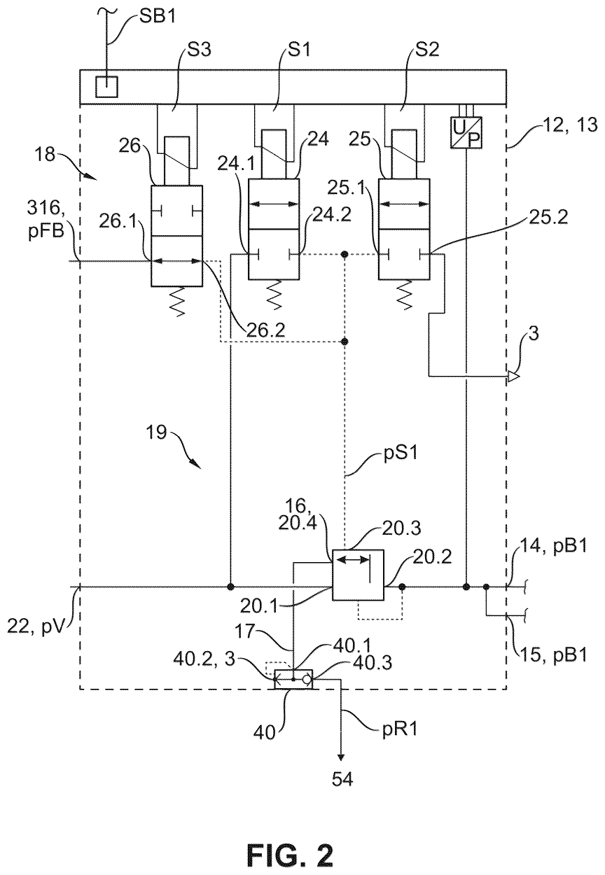

In the primary level B1, the electronically controllable pneumatic brake system 1 includes an electronic service brake (normal brake) control unit 10 that controls the electronically controllable pneumatic brake system 1 in the primary level B1. The electronic service brake (normal brake) control unit 10 is connected to a unit for autonomous driving 210, and receives braking demand signals SA therefrom, via a vehicle bus 212. Furthermore, the electronic service brake (normal brake) control unit 10 is connected to a first voltage source 204, and supplied with electrical voltage therefrom, via a first supply line 203. The electronic service brake (normal brake) control unit 10 converts the braking demand signals SA and, based on these, modulates first service braking (normal braking) signals SB1 at a first brake pressure modulator 12. The first brake pressure modulator 12 is in this case provided for the front axle VA, and can thus also be referred to as a front axle modulator. The first brake pressure modulator 12 is connected to a first compressed-air reservoir 2 and receives reservoir pressure therefrom. Specifically, the reservoir pressure pV is provided at a first reservoir port 22 of the first brake pressure modulator 12. On the basis of the received first service braking (normal braking) signals SB1, the first brake pressure modulator 12 (cf. also FIG. 2) modulates a first service brake (normal brake) pressure pB1 at a first service brake (normal brake) pressure port 14 and, in the embodiment shown in FIG. 1, also at a first further service brake (normal brake) pressure port 15, wherein the first service brake (normal brake) pressure port 14 and the first further service brake (normal brake) pressure port 15 are illustrated separately only in FIG. 1, and are in fact connected in the interior of the first brake pressure modulator 12. In the embodiment shown in FIG. 1, the first service brake (normal brake) pressure pB1 is modulated on an axle-specific basis, such that the same first service brake (normal brake) pressure pB1 is provided in each case at the left-hand side and at the right-hand side of the vehicle 200. The first service brake (normal brake) pressure is conducted initially via first and second front axle ABS valves 220a, 220b in order to then be provided to first and second front axle brake actuators 222a, 222b.

In order to brake the first and the second rear axle HA1, HA2, the electronically controllable pneumatic brake system 1 includes, in the primary level B1, a second brake pressure modulator 100, which in this case is provided for the first and the second rear axle HA1, HA2 and which can thus also be referred to as a rear axle modulator. In the embodiment shown in FIG. 1, the second brake pressure modulator 100 is assembled with the electronic service brake (normal brake) control unit 10 to form one module, which in this case is referred to as central module 102. It should however be understood that the second brake pressure modulator 100 and the electronic service brake (normal brake) control unit 10 may likewise be structurally separate, and may then be connected to one another for example via a signal line. Internally, the electronic service brake (normal brake) control unit 10 modulates second and third service braking (normal braking) signals SB2, SB3 to the second brake pressure modulator 100 in accordance with the braking demand signals SA that the electronic service brake (normal brake) control unit 10 has received from the unit for autonomous driving 210.

The second brake pressure modulator 100 is connected to a second compressed-air reservoir 4 and receives reservoir pressure pV therefrom. In accordance with the second and third service braking (normal braking) signals SB2, SB3, the second brake pressure modulator 100 modulates a second and a third service brake (normal brake) pressure pB2, pB3 on a side-specific basis. The second service brake (normal brake) pressure pB2 is provided to a first and a third rear axle brake actuator 224a, 224c, and the third service brake (normal brake) pressure pB3 is provided to a second and a fourth rear axle brake actuator 224b, 224d.

In the secondary level B2, the electronically controllable pneumatic brake system 1 firstly includes an electronic redundancy control unit 50, which is provided for controlling the electronically controllable pneumatic brake system 1 in the event that the primary level B1 has one or more faults, for example an electrical failure in the first voltage source 204, an electronic fault in the electronic service brake (normal brake) control unit 10, or the like. The electronic redundancy control unit 50 is likewise connected to the unit for autonomous driving 210, and likewise receives braking demand signals SA therefrom, via the vehicle bus 212. By contrast to the electronic service brake (normal brake) control unit 10, however, the electronic redundancy control unit 50 is connected to a second voltage source 206, and supplied with electrical voltage therefrom, via a second supply line 205. The first and second voltage sources 204, 206 are independent of one another, such that a failure in the first voltage source 204 does not lead to a loss of the second voltage source 206, and vice versa. The electronic service brake (normal brake) control unit 10 and the electronic redundancy control unit 50 are thus electrically independent of one another.

In order to be able to exchange signals, the electronic service brake (normal brake) control unit 10 and the electronic redundancy control unit 50 are connected via a redundancy bus 230. In this way, the electronic redundancy control unit 50 can ascertain the availability of the electronic service brake (normal brake) control unit 10 and perform the control of the electronically controllable pneumatic brake system 1 only if the electronic service brake (normal brake) control unit 10 is not available or no longer properly available.

Also provided in the secondary level B2 is a first redundancy pressure modulator 52 which is connected to the electronic redundancy control unit 50 and receives first redundancy braking signals SR1 therefrom. The first redundancy pressure modulator 52 is connected to a first further compressed-air reservoir 2A and receives reservoir pressure therefrom. In principle, the first redundancy pressure modulator 52 may also be connected to the first compressed-air reservoir 2. An additional redundancy is however formed by virtue of the first redundancy pressure modulator 52 being connected to the first further compressed-air reservoir 2A, which is preferably independent of the first compressed-air reservoir 2. The first redundancy pressure modulator 52 modulates a first redundancy brake pressure pR1 at least one first redundancy brake pressure port 54 in accordance with the first redundancy braking signals SR1. The first redundancy brake pressure pR1 is used to redundantly apply compressed air to those brake actuators which are actuated by the first brake pressure modulator 12 in the operational situation, the brake actuators being the first and second front axle brake actuators 222a, 222b in the specific case shown in FIG. 1. According to the concept of the disclosure, provision is made here whereby the first redundancy brake pressure port 54 is connected to a ventilation port 16 of the first brake pressure modulator 12 in order to thus pass the first redundancy brake pressure pR1 through the first brake pressure modulator 12 and modulate same at the first and second front axle brake actuators 222a, 222b, optionally via the first and second front axle ABS valves 220a, 220b that are provided here.

The ventilation port 16, and the first ventilation path 17 (cf. FIG. 2) that is connected thereto, is available even in the event of a fault in the primary level B1 of the electronically controllable pneumatic brake system 1, and is typically open owing to a monostable characteristic of valves. In the operational situation, when the control of the electronically controllable pneumatic brake system is performed by the electronic service brake (normal brake) control unit 10, the venting of the service brake (normal brake) pressure pB1 may, in one case, be performed via the first redundancy pressure modulator 52. The first redundancy pressure modulator may have a vent (not shown in FIG. 1) for this purpose. The first service brake (normal brake) pressure pB1 may furthermore also be vented via the first brake pressure modulator 12, as will be described below.

In order to now also allow redundant braking of the second and third axles of the vehicle 200, in one specific case the first and the second rear axle HA1, HA2, the electronically controllable pneumatic brake system 1 also includes, in the secondary level B2, a second redundancy pressure modulator 60 that is provided for replacing the second brake pressure modulator 100. In the embodiment shown here, the second redundancy pressure modulator 60 is integrated with the electronic redundancy control unit 50 into a redundancy module 51, similarly to the situation described above with regard to the central module 102. The electronic redundancy control unit 50 thus provides second and third redundancy braking signals SR2, SR3 to the second redundancy pressure modulator 60. The second redundancy pressure modulator 60 is connected to a second further compressed-air reservoir 4A, though may likewise be connected to the second compressed-air reservoir 4. Additional redundancy in the compressed-air reservoirs can be established by virtue of the second redundancy pressure modulator 60 being connected to the second further compressed-air reservoir 4A. The second further compressed-air reservoir 4A is preferably independent of the second compressed-air reservoir 4. Provision may also be made whereby the second further compressed-air reservoir 4A and the first further compressed-air reservoir 2A are one common compressed-air reservoir, and can thus be referred to jointly as further compressed-air reservoir. It would also be conceivable to introduce crosswise redundancy by virtue of a supply being provided to the second redundancy pressure modulator 60 by the second compressed-air reservoir 2 while a supply is provided to the first redundancy pressure modulator 52 by second compressed-air reservoir 4.

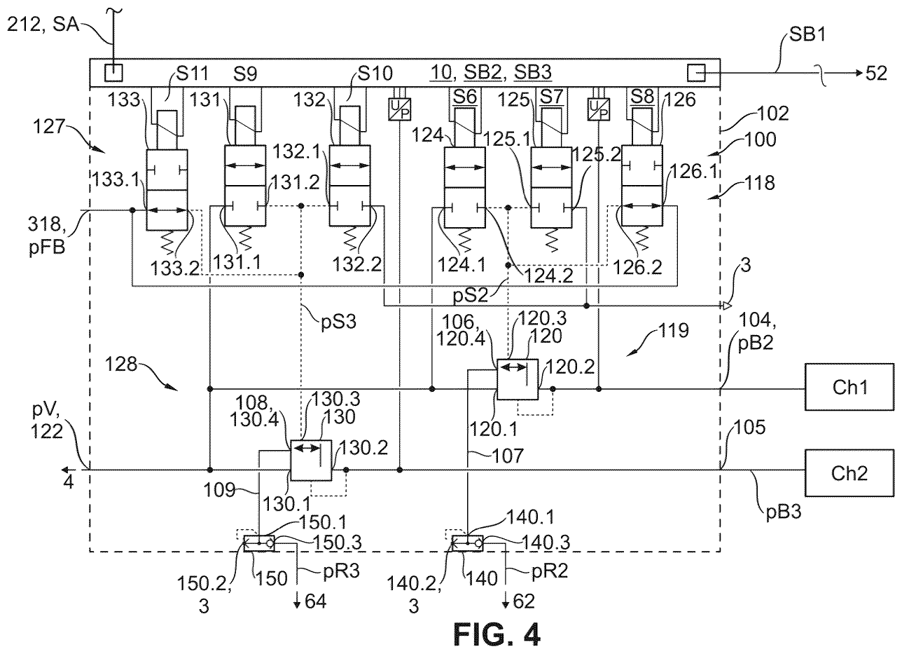

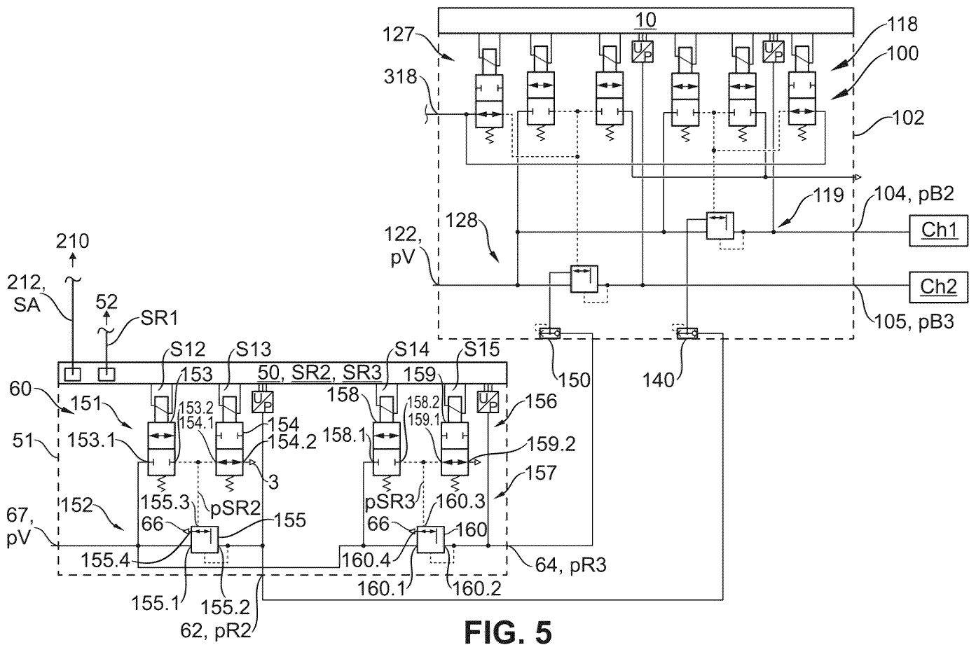

The second redundancy pressure modulator modulates a second redundancy brake pressure pR2 for the right-hand vehicle side, and thus for the first and third rear axle brake actuators 224a, 224c, at a second redundancy brake pressure port 62, and modulates a third redundancy brake pressure pR3 for the left-hand vehicle side, specifically for the second and fourth rear axle brake actuators 224b, 224d, at a third redundancy brake pressure port 164. The second redundancy brake pressure port 62 is, for this purpose, connected to a second ventilation port 106 of the second brake pressure modulator 100, and the third redundancy brake pressure port 64 is connected to a third ventilation port 108 of the second brake pressure modulator 100, as will be discussed in more detail with reference to FIGS. 4 and 5.

Furthermore, the electronically controllable pneumatic brake system 1 according to the embodiment shown here (FIG. 1) has a trailer control valve 180 in order to be able to supply compressed air to, and brake, any trailer of the vehicle 200. The trailer control valve 180 has a trailer brake pressure port 182 for providing a trailer brake pressure pBA and has a trailer reservoir port 183 for receiving reservoir pressure pV, in this case from the first compressed-air reservoir 2. The trailer control valve 180 also has a further trailer reservoir port 184, which is connected to the second compressed-air reservoir 4 and likewise receives reservoir pressure pV. The electronically controllable pneumatic brake system 1 shown in FIG. 1 is provided for the North American market, in which it is typical for a supply to be provided to the trailer control valve 180 from two different compressed-air reservoirs. This may differ in variants configured for the European market.

The trailer control valve 180 furthermore has a trailer ventilation port 186 for venting the trailer brake pressure pBA. In the embodiment shown here, the first redundancy pressure modulator 52 is, specifically via a trailer redundancy brake pressure port 56 at which a trailer redundancy pressure pRA is modulated, which in the embodiment shown here (FIG. 1) preferably corresponds to the first redundancy brake pressure pR1, connected to the trailer ventilation port 186. In this way, redundant braking of the trailer is also possible using a ventilation path of the trailer control valve 180.

Finally, in the embodiment shown here, the electronically controllable pneumatic brake system 1 has a brake signal transmitter 300 that is configured as a footbrake valve. The brake signal transmitter 300 is connected via a first brake signal transmitter line 302 to the electronic service brake (normal brake) control unit 10, and via a second brake signal transmitter line 304 to the electronic redundancy control unit 50. Via these two lines, the brake signal transmitter 300 provides footbrake braking signals SFB to the electronic service brake (normal brake) control unit 10 and to the electronic redundancy control unit 50, which, on the basis of the footbrake braking signals SFB, can likewise modulate the first, second and third service braking (normal braking) signals SB1, SB2, SB3 and the first, second and third redundancy braking signals SR1, SR2, SR3. The brake signal transmitter 300 furthermore includes a brake signal transmitter brake pressure port 306 at which a brake signal transmitter brake pressure pFB can be modulated. The brake signal transmitter brake pressure is provided via a front axle footbrake line 310 to the first brake pressure modulator 12, via a rear axle footbrake line 312 to the second brake pressure modulator 100, and via a trailer footbrake line 314 to the trailer control valve 180, in order to thus be able to brake the vehicle 200 purely pneumatically using the brake signal transmitter brake pressure pFB that is modulated via the brake signal transmitter 300.

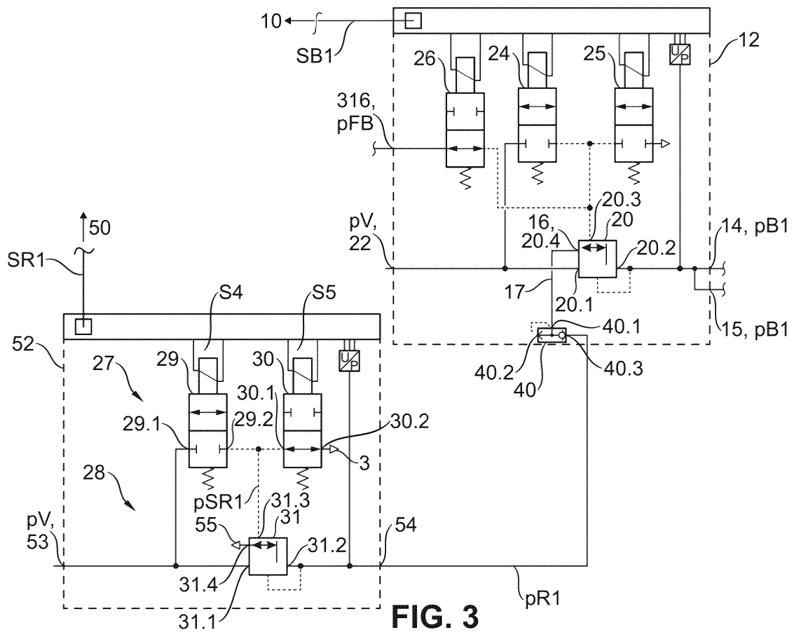

FIGS. 2 and 3 firstly illustrate the first brake pressure modulator 12 and the first redundancy pressure modulator 52, and the interaction thereof. The first brake pressure modulator 12 includes a pilot control unit 18 and a main valve unit 19, which in this case has a first service brake (normal brake) relay valve 20. The first pilot control unit 18 serves to modulate a first pilot control pressure pS1 at the main valve unit 19. The first brake pressure modulator 12 is in principle of similar configuration to known brake pressure modulators, and includes a reservoir port 22 which is connected to the first compressed-air reservoir 2 and which receives reservoir pressure pV therefrom (cf. FIG. 1). The first brake pressure modulator also includes a first service brake (normal brake) pressure port 14 at which the first service brake (normal brake) pressure pB1 is modulated. A first further service brake (normal brake) pressure port 15 is likewise provided, which is fluidically connected to the first service brake (normal brake) pressure port 14.

The first pilot control valve 18 includes a first inlet valve 24, a first outlet valve 25 and a first redundancy valve 26. The first inlet valve 24 is configured here as a monostable 2/2 directional solenoid valve, and is spring-preloaded into the closed switching position shown in FIG. 2. The first inlet valve 24 has a first inlet valve port 24.1, which is connected to the first reservoir port 22 and which receives reservoir pressure pV therefrom. The first inlet valve 24 has a second inlet valve port 24.2 which is connected to, and can modulate the first pilot control pressure pS1 at, the first service brake (normal brake) relay valve control port 20.3. The first inlet valve 24 is switched on the basis of a first switching signal S1, which may be provided directly by the electronic service brake (normal brake) control unit 10 if not by a dedicated electronic control unit of the first brake pressure modulator 12. If the first brake pressure modulator 12 has a dedicated electronic control unit, this provides the first switching signal S1 on the basis of the received first service braking (normal braking) signal SB1 in order to move the first valve 24 into the switching position that is not shown in FIG. 2 and thus modulate the first control pressure pS1. The first outlet valve 25 is likewise configured as a monostable 2/2 directional solenoid valve, and is stable in the closed switching position shown in FIG. 2. The first outlet valve 25 has a first outlet valve port 25.1, which is likewise connected to the first service brake (normal brake) relay valve control port 20.3. A second outlet valve port 25.2 is connected to a vent 3. The first outlet valve 25 may be switched by way of a second switching signal S2 into the open switching position that is not shown in FIG. 2 in order to thus vent the first pilot control pressure pS1. The first redundancy valve 26 includes a first redundancy valve port 26.1 and a second redundancy valve port 26.2. The first redundancy valve is likewise configured as a monostable 2/2 directional solenoid valve, but is preloaded into an open switching position as shown in FIG. 2, and when electrically energized is moved into a closed switching position that is not shown in FIG. 2. The first redundancy valve 26 can be moved into the closed switching position that is not shown in FIG. 2 by way of a third switching signal S3. The first redundancy valve port 26.1 is connected to a first footbrake pressure port 316, at which the brake signal transmitter brake pressure pFB can be modulated. If the vehicle 200 is in autonomous operation and if the unit for autonomous driving 210 assumes control, then the first redundancy valve 26 should be closed. Only if the first redundancy valve 26 is moved into the open switching position can the brake signal transmitter brake pressure pFB be passed through the first redundancy valve 26 and modulated at the first service brake (normal brake) relay valve control port 20.3. In this way, the manual fall-back level B3 can be implemented, and manual control of the vehicle 200 is possible.

The first service brake (normal brake) relay valve 20 includes a first service brake (normal brake) relay valve reservoir port 20.1, which is connected to the reservoir port 22 and which receives reservoir pressure therefrom. The service brake (normal brake) relay valve furthermore includes a first service brake (normal brake) relay valve working port 20.2, which is connected to the first service brake (normal brake) pressure port 14 and optionally to the first further service brake (normal brake) pressure port 15. In accordance with the first control pressure pS1 that is received at the first service brake (normal brake) relay valve control port 20.3, the first service brake (normal brake) relay valve 20 modulates the first service brake (normal brake) pressure pB1, which then preferably corresponds to a control pressure pS1 that has been boosted in volume. For the ventilation of the first service brake (normal brake) relay valve and in particular in order to vent the first service brake (normal brake) pressure pB1, the first service brake (normal brake) relay valve 20 includes a first service brake (normal brake) relay valve ventilation port 20.4, which also forms the first ventilation port 16 of the first brake pressure modulator 12. The first service brake (normal brake) relay valve ventilation port is adjoined by a first ventilation path 17 of the first brake pressure modulator 12, the first ventilation path extending within the first brake pressure modulator housing 13 of the first brake pressure modulator 12. Provided in the first ventilation path 17 is a first rapid ventilation valve 40 which serves for venting the first service brake (normal brake) pressure pB1. The first rapid ventilation valve 40 has a first rapid ventilation valve port 40.1, which is connected to the ventilation path 17 and which, in situation shown here, is connected specifically to the first service brake (normal brake) relay valve ventilation port 20.4. A second rapid ventilation valve port 40.2 is connected to the surroundings or to a vent 3, and a third rapid ventilation valve port 40.3 is connected to the first redundancy brake pressure port 54 of the first redundancy pressure modulator 52 (cf. FIGS. 1 and 3). In this way, it is firstly possible for the first service brake (normal brake) pressure pB1 to be rapidly vented via the rapid ventilation valve 40 and the second rapid ventilation valve port 40.2, and secondly, the first redundancy pressure pR1 can be introduced via the first rapid ventilation valve 40, more specifically via the third rapid ventilation valve port 40.3, the first rapid ventilation valve port 40.1 and the first service brake (normal brake) relay valve ventilation port 20.4, and thus also modulated at the first service brake (normal brake) pressure port 14 and preferably the first further service brake (normal brake) pressure port 15.

The first rapid ventilation valve 40 is in this case likewise integrated into the first brake pressure modulator housing 13, though it may likewise be situated outside and connected to the first brake pressure modulator housing. This is preferable for example if the first ventilation valve port 16 is provided on the outside of, and not within, the first brake pressure modulator housing 13. In this case, the first ventilation port 16 arranged on the housing could then be connected to the externally provided first rapid ventilation valve 40. As can be seen from FIG. 3, the first redundancy pressure modulator 52 includes a first redundancy pilot control unit 27 and a first redundancy main valve unit 28. The first redundancy pilot control unit 27 includes a first redundancy inlet valve 29 and a first redundancy outlet valve 30. The first redundancy main valve unit 28 includes a first redundancy relay valve 31. The first redundancy pressure modulator 52 is thus of corresponding construction to the first brake pressure modulator 12, aside from the fact that the first redundancy pressure modulator 52 does not include the first redundancy valve 26 because it does not need to implement pneumatic redundancy. The first redundancy inlet valve 29 is configured here as a monostable 2/2 directional solenoid valve, and is preloaded, when electrically deenergized, into the closed switching position shown in FIG. 3. The first redundancy inlet valve has a first redundancy inlet valve port 29.1 which is connected to a first redundancy reservoir port 53, which in turn is connected to the further first compressed-air reservoir 2A and receives reservoir pressure pV therefrom. A second redundancy inlet valve port 29.2 is connected to, and modulates a first redundancy pilot control pressure pSR1 at, the first redundancy main valve unit 28. The first redundancy outlet valve 30 serves for venting the first redundancy pilot control pressure pSR1, and for this purpose is in turn configured as a monostable 2/2 directional solenoid valve, which is however preloaded, when electrically deenergized, into the open switching position (cf. FIG. 3). This is advantageous in order to achieve that, in the normal situation, the first redundancy pilot control pressure pSR1 is vented, and thus the first redundancy relay valve 31 is also held in a ventilated position.

The first redundancy outlet valve 30 includes a first redundancy outlet valve port 30.1, which is connected to the redundancy relay valve 31, and a second redundancy outlet valve port 30.2, which is connected to a or the vent 3.

The fourth and the fifth switching signal for switching the first redundancy inlet valve 29 and the first redundancy outlet valve 30 may in turn be provided directly by the electronic redundancy control unit 50, or the first redundancy pressure modulator 52 includes a dedicated control unit which converts the first redundancy braking signal SR1 and, based on this, modulates the fourth and the fifth switching signal S4, S5.

The first redundancy relay valve 31 includes a first redundancy relay valve reservoir port 31.1, which is connected to the first redundancy reservoir port 53 and which receives reservoir pressure pV therefrom. A first redundancy relay valve working port 31.2 is connected to the first redundancy brake pressure port 54 in order to modulate the first redundancy brake pressure pR1 at the first redundancy brake pressure port. The first redundancy relay valve 31 furthermore includes a first redundancy relay valve control port 31.3, which is connected to the first redundancy pilot control port 27 and which receives the first redundancy pilot control pressure pSR1 therefrom. The first redundancy relay valve 31 boosts the volume of the pressure and modulates it as first redundancy brake pressure pR1. Furthermore, the first redundancy relay valve 31 has a first redundancy relay valve ventilation port 31.4 which is connected to, or forms, a first redundancy ventilation port 55. The first redundancy brake pressure pR1 can be vented via the first redundancy ventilation port. If no first rapid ventilation valve 40 is provided, but instead the first redundancy brake pressure port 54 is connected for example directly to the first ventilation port 16, more specifically to the first service brake (normal brake) relay valve ventilation port 20.4, the first service brake (normal brake) pressure pB1 can also be vented via the first redundancy ventilation port 55.

FIGS. 4 and 5 now show, similarly to FIGS. 2 and 3, the construction of the second brake pressure modulator 100, and the interaction of the second brake pressure modulator 100 with the second redundancy pressure modulator 60.

As described in the introduction, the second brake pressure modulator 100 is integrated with the electronic service brake (normal brake) control unit 10 to form a central module 102. It can be seen in FIG. 4 that the electronic service brake (normal brake) control unit 10 receives braking demand signals SA, and also modulates the first service braking (normal braking) signal SB1 at the first redundancy pressure modulator 52, via the vehicle bus 212.

The second brake pressure modulator 100 is configured as a two-channel modulator and has a second service brake (normal brake) pressure port 104 and a third service brake (normal brake) pressure port 105, which are independent of one another. For the first channel, specifically the second service brake (normal brake) pressure port 104, a second pilot control unit 118 is provided, along with a second main valve unit 119. Both the second pilot control unit 118 and the second main valve unit 119 are identical to the first main valve unit 19, such that reference is made in principle to the description above. Here, the second pilot control unit 118 includes a second inlet valve 124 having a third inlet valve port 124.1, which is connected to the second reservoir port 122 and receives reservoir pressure pV therefrom. A fourth inlet valve port 124.2 modulates a second pilot control pressure pS2, which is provided to the second service brake (normal brake) relay valve 120. The second outlet valve 125 includes a third outlet valve port 125.1, which is connected to the second service brake (normal brake) relay valve 120, and a fourth outlet valve port 125.2, which is connected to a or the vent 3. The second outlet valve 125 is switched on the basis of a sixth switching signal that is provided by the electronic service brake (normal brake) control unit 10, while the second outlet valve 125 is switched by way of a seventh switching signal S7 that is likewise provided by the electronic service brake (normal brake) control unit 10. A second redundancy valve 126 has a third redundancy valve port 126.1 which is connected to a second footbrake pressure port 318 and, via this, receives the brake signal transmitter brake pressure pFB. The second redundancy valve can then, if it is in the open switching position shown in FIG. 4, pass the brake signal transmitter brake pressure through to the fourth redundancy valve port 126.2 and provide the brake signal transmitter brake pressure to the second service brake (normal brake) relay valve 120. Pneumatic redundancy can be implemented in this way, as has also already been described with reference to the first brake pressure modulator 12.

The second service brake (normal brake) relay valve 120 includes a second service brake (normal brake) relay valve reservoir port 120.1, which is connected to the second reservoir port 122 and receives reservoir pressure pV, a second service brake (normal brake) relay valve working port 120.2, which is connected to the second service brake (normal brake) pressure port 104, a second service brake (normal brake) relay valve control port 120.3, which receives the second pilot control pressure pS2 and is connected to the second pilot control unit 118, and a second service brake (normal brake) relay valve ventilation port 120.4. In the embodiment shown here, the second service brake (normal brake) relay valve ventilation port 120.4 forms the second ventilation port of the second brake pressure modulator 100. This leads into a second ventilation path 107, in which a second rapid ventilation valve 140 is provided, as has also been described with reference to FIGS. 2 and 3. The second rapid ventilation valve 140 has a fourth rapid ventilation valve port 140.1, which is connected to the second ventilation port 106 or more specifically to the second service brake (normal brake) relay valve ventilation port 120.4. A fifth rapid ventilation valve port 140.2 is connected to a vent or to the surroundings, and a sixth rapid ventilation valve port 140.3 is connected to the second redundancy brake pressure port 62 and can receive the second redundancy brake pressure pR2 therefrom (cf. FIG. 1). Via the second rapid ventilation valve 140, it is thus possible for the second redundancy brake pressure pR2 to be fed to the second ventilation path 107 and thus to the second service brake (normal brake) relay valve ventilation port 120.4 in order, in the event of a fault of the electronic service brake (normal brake) control unit 10 which has the effect, for example, that the sixth and the seventh switching signal can no longer be correctly provided and thus the second pilot control pressure pS2 can also no longer be correctly modulated, to modulate the second redundancy brake pressure pR2 at the second service brake (normal brake) pressure port 104 in order to be able to thus provide the second redundancy brake pressure to the first and third rear axle brake actuators 224a, 224c.

For the second channel, specifically the third service brake (normal brake) pressure port 105, an identical valve arrangement is provided, having a third pilot control unit 127 and a third main valve unit 128 that includes a third service brake (normal brake) relay valve 130. The third pilot control unit has a third inlet valve 131 and a third outlet valve 132. The third pilot control unit furthermore has a third redundancy valve 133. The third inlet valve 131 is in turn configured as a monostable 2/2 directional solenoid valve and, when electrically deenergized, is situated in the closed switching position shown in FIG. 4. The third inlet valve includes a fifth inlet valve port 131.1 which is connected to the second reservoir port 122 and receives reservoir pressure pV. A sixth inlet valve port 131.2 is connected to, and modulates a third pilot control pressure pS3 at, the third main valve unit 128. The third outlet valve 132 is connected by way of a fifth outlet valve port 132.1 to the third main valve unit 128 and can thus vent the third pilot control pressure pS3. A sixth outlet valve port 132.2 of the third outlet valve 132 is connected to a or the vent 3. The third inlet valve 131 can be switched by way of a ninth switching signal S9, and the third outlet valve 132 can be switched by way of a tenth switching signal S10. The third redundancy valve 133 includes a fifth redundancy valve port 133.1, which is connected to the second footbrake pressure port 318 and thus receives the brake signal transmitter brake pressure pFB. When electrically deenergized, the third redundancy valve 133 is situated in the open switching position shown in FIG. 4, and can then pass the brake signal transmitter brake pressure pFB through to a sixth redundancy valve port 133.2 and provide the brake signal transmitter brake pressure as third pilot control pressure pS3.

The third service brake (normal brake) relay valve 130 has a third service brake (normal brake) relay valve reservoir port 130.1, which is connected to the second reservoir port 122, a third service brake (normal brake) relay valve working port 130.2, which is connected to the third service brake (normal brake) pressure port 105, a third service brake (normal brake) relay valve control port 130.3, at which the third pilot control pressure pS3 is modulated, and a third service brake (normal brake) relay valve ventilation port 130.4, which in this case also forms the third ventilation port 108 of the second brake pressure modulator 100 and which leads into a third ventilation path 109. A third rapid ventilation valve 150 is provided in the third ventilation path 109. The third rapid ventilation valve 150 is identical to the second rapid ventilation valve 140 and has a seventh rapid ventilation valve port 150.1 that is connected to the third ventilation port, more specifically to the third service brake (normal brake) relay valve ventilation port 130.4. An eighth rapid ventilation valve port 150.2 is connected to a or the vent 3, and a ninth rapid ventilation valve port 150.3 is connected to the third redundancy brake pressure port 64 of the second redundancy pressure modulator 60 and receives the third redundancy brake pressure therefrom. For the second channel, too, the third redundancy brake pressure can thus be passed through the third ventilation path 109 and provided at the third service brake (normal brake) pressure port 105.

In order to correspond to the second brake pressure modulator 100, the second redundancy pressure modulator 60 is also of two-channel configuration. As described with reference to FIG. 1, the second redundancy pressure modulator is integrated with the electronic redundancy control unit 50 into a redundancy module 51 and, for the second redundancy brake pressure port 62, includes a valve unit having a second redundancy pilot control unit 151 and a second redundancy main valve unit 152. The second redundancy pilot control unit 151 has a second redundancy inlet valve 153 having a third redundancy inlet valve port 153.1, which is connected to a second redundancy reservoir port 67 and receives reservoir pressure pV therefrom. The second redundancy reservoir port 67 is connected to the second compressed-air reservoir 4 or to the second further compressed-air reservoir 4A. A fourth redundancy inlet valve port 153.2 is connected to, and modulates a second redundancy pilot control pressure pSR2 at, the second redundancy main valve unit 152. The second redundancy outlet valve 154 is connected by way of a third redundancy outlet valve port 154.1 to the second redundancy main valve unit 152 and can thus vent the second redundancy pilot control pressure pSR2. The fourth redundancy outlet valve port 154.2 is connected to a or the vent 3. The second redundancy outlet valve is in turn configured as a monostable 2/2 directional solenoid valve and, when electrically deenergized, is situated in the open switching position shown in FIG. 5. While the second redundancy inlet valve 153 can be switched by way of a twelfth switching signal S12, the second redundancy outlet valve 154 can be switched by way of a thirteenth switching signal S13.

The second redundancy main valve unit 152 includes a second redundancy relay valve 155 having a second redundancy relay valve reservoir port 155.1, which is connected to the second redundancy reservoir port 67 and receives reservoir pressure pV, having a second redundancy relay valve working port 155.2, which is connected to the second redundancy brake pressure port 62 in order to modulate the second redundancy brake pressure pR2 at the second redundancy brake pressure port, having a second redundancy relay valve control port 155.3, which is connected to the second redundancy pilot control unit 151 and receives the second redundancy pilot control pressure pSR2, and having a second redundancy relay valve ventilation port 155.4, which is connected to a or the vent 3 and serves to vent the second redundancy brake pressure pR2. If no second rapid ventilation valve 140 is provided, but instead the second redundancy brake pressure port 62 is connected directly to the second service brake (normal brake) relay valve ventilation port 120.4, the second service brake (normal brake) pressure pB2 can also be vented via the second redundancy relay valve ventilation port 155.4.

For the second channel, the second redundancy pressure modulator analogously includes a valve arrangement that is identical to the valve arrangement for the first channel of the second redundancy pressure modulator 60. Specifically, the second redundancy pressure modulator includes a third redundancy pilot control unit 156 and a third redundancy main valve unit 157. The third redundancy pilot control unit 156 serves to modulate a third redundancy control pressure pSR3 at the third redundancy main valve unit 157. The third redundancy pilot control unit 156 includes a third redundancy inlet valve 158 having a fifth redundancy inlet valve port 158.1 which is connected to the second redundancy reservoir port 67 and receives reservoir pressure pV therefrom. A sixth redundancy inlet valve port 158.2 is then connected to, and modulates the third redundancy control pressure pSR3 at, the third redundancy main valve unit 157. In order to vent the third redundancy control pressure pSR3, the third redundancy pilot control unit 156 includes a third redundancy outlet valve 159 having a fifth redundancy outlet valve port 159.1, which is connected to the third redundancy main valve unit 157, and a sixth redundancy outlet valve port 159.2, which is connected to a or the vent 3. The third redundancy main valve unit 157 includes a third redundancy relay valve 160 having a third redundancy relay valve reservoir port 160.1 which is connected to the second redundancy reservoir port 67 and receives reservoir pressure. A third redundancy relay valve working port 160.2 is connected to, and modulates the third redundancy brake pressure pR3 at, the third redundancy brake pressure port 64. A third redundancy relay valve control port 160.3 is connected to the third redundancy pilot control unit 156 and receives the third redundancy pilot pressure pSR3 therefrom. A third redundancy relay valve ventilation port 160.4 is connected to a or the vent 3. In this case, too, if no third rapid ventilation valve 150 is provided, but instead the third redundancy brake pressure port 64, the third service brake (normal brake) pressure pB3 can also be vented via the third redundancy relay valve 160.

The third redundancy inlet valve 158 can be switched by way of a fourteenth switching signal S14, and the third redundancy outlet valve 159 can be switched by way of a fifteenth switching signal S15.

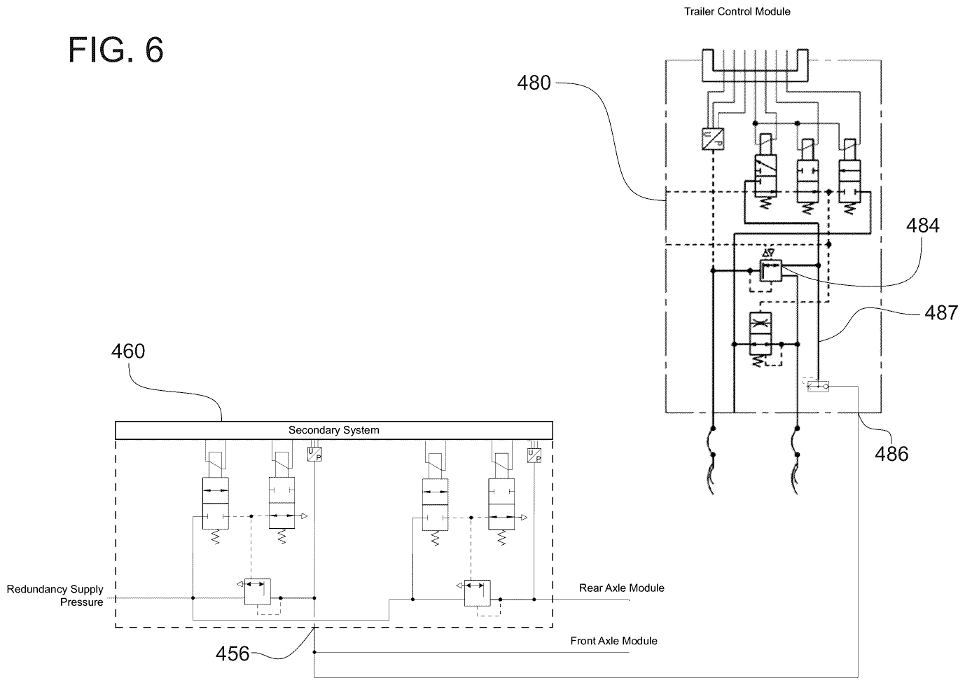

FIG. 6 shows a trailer control module 480. A ventilation path 487 leads from a trailer ventilation port 486 to a trailer redundancy brake pressure port 484. The trailer redundancy brake pressure port 484 of the trailer control module 480 is connected to the trailer redundancy brake pressure port 456 of the redundancy system 460. Accordingly, the trailer redundancy pressure (PRA) can be modulated at the trailer redundancy brake pressure port 484 via the trailer ventilation path 487 of the trailer control module 480.

It is understood that the foregoing description is that of the preferred embodiments of the invention and that various changes and modifications may be made thereto without departing from the spirit and scope of the invention as defined in the appended claims.

### LIST OF REFERENCE DESIGNATIONS (PART OF THE DESCRIPTION)

1 Electronically controllable pneumatic brake system
2 First compressed-air reservoir
2A First further compressed-air reservoir
3 Vent
4 Second compressed-air reservoir
4A Second further compressed-air reservoir
10 Electronic service brake (normal brake) control unit
12 First brake pressure modulator
13 First brake pressure modulator housing
14 First service brake (normal brake) pressure port
15 First further service brake (normal brake) pressure port
16 First ventilation port
17 First ventilation path
18 First pilot control unit
19 First main valve unit
20 First service brake (normal brake) relay valve
20.1 First service brake (normal brake) relay valve reservoir port
20.2 First service brake (normal brake) relay valve working port
20.3 First service brake (normal brake) relay valve control port
20.4 First service brake (normal brake) relay valve ventilation port
22 First reservoir port
24 First inlet valve
24.1 First inlet valve port
24.2 Second inlet valve port
25 First outlet valve
25.1 First outlet valve port
25.2 Second outlet valve port
26 First redundancy valve
26.1 First redundancy valve port
26.2 Second redundancy valve port
27 First redundancy pilot control unit
28 First redundancy main valve unit
29 First redundancy inlet valve
29.1 First redundancy inlet valve port
29.2 Second redundancy inlet valve port
30 First redundancy outlet valve
30.1 First redundancy outlet valve port
30.2 Second redundancy outlet valve port
31 First redundancy relay valve
31.1 First redundancy relay valve reservoir port
31.2 First redundancy relay valve working port
31.3 First redundancy relay valve control port
31.4 First redundancy relay valve ventilation port
40 First rapid ventilation valve
40.1 First rapid ventilation valve port
40.2 Second rapid ventilation valve port
40.3 Third rapid ventilation valve port
50 Electronic redundancy control unit
51 Redundancy module
52 First redundancy pressure modulator
53 First redundancy reservoir port
54 First redundancy brake pressure port
55 First redundancy ventilation port
56 Trailer redundancy brake pressure port
60 Second redundancy pressure modulator
62 Second redundancy brake pressure port
64 Third redundancy brake pressure port
66 Second redundancy modulator vent
67 Second redundancy reservoir port
100 Second brake pressure modulator
102 Central module
104 Second service brake (normal brake) pressure port
105 Third service brake (normal brake) pressure port
106 Second ventilation port
107 Second ventilation path
108 Third ventilation port
109 Third ventilation path
118 Second pilot control unit
119 Second main valve unit
120 Second service brake (normal brake) relay valve
120.1 Second service brake (normal brake) relay valve reservoir port
120.2 Second service brake (normal brake) relay valve working port
120.3 Second service brake (normal brake) relay valve control port
120.4 Second service brake (normal brake) relay valve ventilation port
122 Second reservoir port
124 Second inlet valve
124.1 Third inlet valve port
124.2 Fourth inlet valve port
125 Second outlet valve
125.1 Third outlet valve port
125.2 Fourth outlet valve port
126 Second redundancy valve
126.1 Third redundancy valve port
126.2 Fourth redundancy valve port
127 Second pilot control unit
128 Second main valve unit
130 Third service brake (normal brake) relay valve
130.1 Third service brake (normal brake) relay valve reservoir port
130.2 Third service brake (normal brake) relay valve working port
130.3 Third service brake (normal brake) relay valve control port
130.4 Third service brake (normal brake) relay valve ventilation port
131 Third inlet valve
131.1 Fifth inlet valve port
131.2 Sixth inlet valve port
132 Third outlet valve
132.1 Fifth outlet valve port
132.2 Sixth outlet valve port
133 Third redundancy valve
133.1 Fifth redundancy valve port
133.2 Sixth redundancy valve port
140 Second rapid ventilation valve
140.1 Fourth rapid ventilation valve port
140.2 Fifth rapid ventilation valve port
140.3 Sixth rapid ventilation valve port
150 Third rapid ventilation valve
150.1 Seventh rapid ventilation valve port
150.2 Eighth rapid ventilation valve port
150.3 Ninth rapid ventilation valve port
151 Second redundancy pilot control unit
152 Second redundancy main valve unit
153 Second redundancy inlet valve
153.1 Third redundancy inlet valve port
153.2 Fourth redundancy inlet valve port
154 Second redundancy outlet valve
154.1 Third redundancy outlet valve port
154.2 Fourth redundancy outlet valve port
155 Second redundancy relay valve
155.1 Second redundancy relay valve reservoir port
155.2 Second redundancy relay valve working port
155.3 Second redundancy brake relay valve control port
155.4 Second redundancy relay valve ventilation port
156 Third redundancy pilot control unit
157 Third redundancy main valve unit
158 Third redundancy inlet valve
158.1 Fifth redundancy inlet valve port
158.2 Sixth redundancy inlet valve port
159 Third redundancy outlet valve
159.1 Fifth redundancy outlet valve port
159.2 Sixth redundancy outlet valve port
160 Third redundancy relay valve
160.1 Third redundancy relay valve reservoir port
160.2 Third redundancy relay valve working port
160.3 Third redundancy relay valve control port
160.4 Third redundancy relay valve ventilation port
180 Trailer control valve
182 Trailer brake pressure port
183 Trailer reservoir port
184 Further trailer reservoir port
186 Trailer ventilation port
200 Vehicle
202 Utility vehicle
203 First supply line
204 First voltage source
205 Second supply line
206 Second voltage source
210 Unit for autonomous driving
212 Vehicle bus
220a First front axle ABS valve
220b Second front axle ABS valve
222a First front axle brake actuator
222b Second front axle brake actuator
224a First rear axle brake actuator
224b Second rear axle brake actuator
224c Third rear axle brake actuator
224d Fourth rear axle brake actuator
230 Redundancy bus
300 Brake signal transmitter
302 First brake signal transmitter line
304 Second brake signal transmitter line
306 Brake signal transmitter brake pressure port
310 Front axle footbrake line
312 Rear axle footbrake line
314 Trailer footbrake line
316 First footbrake pressure port
318 Second footbrake pressure port
456 Trailer redundancy brake pressure port
460 Redundancy system
480 Trailer control module
484 Trailer redundancy brake pressure port
486 Trailer ventilation port
487 Ventilation path
B1 Primary level
B2 Secondary level
B3 Manual level
HA1 First rear axle
HA2 Second rear axle
pB1 First service brake (normal brake) pressure
pB2 Second service brake (normal brake) pressure
pB3 Third service brake (normal brake) pressure
pFB Brake signal transmitter brake pressure
pR1 First redundancy brake pressure
pR2 Second redundancy brake pressure
pR3 Third redundancy brake pressure
PRA Trailer redundancy pressure
ps1 First pilot control pressure
ps2 Second pilot control pressure
pS3 Third pilot control pressure
pSR1 First redundancy pilot control pressure
pSR2 Second redundancy pilot control pressure
pSR3 Third redundancy pilot control pressure
pv Reservoir pressure
SA Braking demand signal
SB1 First service braking (normal braking) signals
SB2 Second service braking (normal braking) signals
SB3 Third service braking (normal braking) signals
SFB Footbrake braking signals
SR1 First redundancy braking signals
SR2 Second redundancy braking signals
SR3 Third redundancy braking signals
S1 First switching signal
S2 Second switching signal
S3 Third switching signal
S4 Fourth switching signal
S5 Fifth switching signal
S6 Sixth switching signal
S7 Seventh switching signal
S8 Eighth switching signal
S9 Ninth switching signal
S10 Tenth switching signal
S11 Eleventh switching signal
S12 Twelfth switching signal
S13 Thirteenth switching signal
S14 Fourteenth switching signal
S15 Fifteenth switching signal
VA Front axle

1. An electronically controllable pneumatic brake system for a vehicle, the electronically controllable pneumatic brake system comprising:
an electronic service brake control unit;
a first brake pressure modulator connected to a first compressed-air reservoir in order to receive reservoir pressure and configured to modulate a first service brake pressure at least at one first service brake pressure port in accordance with first service braking signals that are provided by said electronic service brake control unit;
said first brake pressure modulator having a first ventilation port for venting the first service brake pressure;
an electronic redundancy control unit;
a first redundancy pressure modulator connected to the first compressed-air reservoir or to a further compressed-air reservoir in order to receive reservoir pressure and configured to modulate a first redundancy brake pressure at least at one first redundancy brake pressure port in accordance with first redundancy braking signals provided by said electronic redundancy control unit;
said first redundancy pressure modulator having a first redundancy ventilation port for venting the first redundancy brake pressure; and,
said at least one first redundancy brake pressure port being connected to said first ventilation port such that the at least one first redundancy brake pressure is configured to be modulated, via a first ventilation path of said first brake pressure modulator, at said at least one first service brake pressure port.

2. The electronically controllable pneumatic brake system of claim 1, wherein said first brake pressure modulator has a first rapid ventilation valve at said first ventilation port for venting the at least one first service brake pressure.

3. The electronically controllable pneumatic brake system of claim 2, wherein said first rapid ventilation valve has a first rapid ventilation valve port connected to said first ventilation path, a second rapid ventilation valve port connected to surroundings, and a third rapid ventilation valve port connected to said at least one first redundancy brake pressure port.

4. The electronically controllable pneumatic brake system of claim 1, wherein said first brake pressure modulator has a first service brake relay valve, said first service brake relay valve has a first service brake relay valve reservoir port connected to a first reservoir port, a first service brake relay valve working port connected to said at least one first service brake pressure port, a first service brake relay valve control port configured to receive a first pilot control pressure, and a first service brake relay valve ventilation port, which forms or is connected to said first ventilation port.

5. The electronically controllable pneumatic brake system of claim 3, wherein said first brake pressure modulator has a first service brake relay valve, said first service brake relay valve has a first service brake relay valve reservoir port connected to a first reservoir port, a first service brake relay valve working port connected to said first service brake pressure port, a first service brake relay valve control port configured to receive a first pilot control pressure, and a first service brake relay valve ventilation port, which forms or is connected to said first ventilation port; and, wherein said first service brake relay valve ventilation port is connected to a first rapid ventilation valve port.

6. The electronically controllable pneumatic brake system of claim 1 further comprising:
a second brake pressure modulator connected to a second compressed-air reservoir in order to receive reservoir pressure and configured to modulate at least one second service brake pressure at least at one second service brake pressure port in accordance with second service braking signals provided by said electronic service brake control unit;
said second brake pressure modulator having a second ventilation port for venting the at least one second service brake pressure;
a second redundancy pressure modulator connected to the second compressed-air reservoir or to a second further compressed-air reservoir in order to receive reservoir pressure and configured to modulate a second redundancy brake pressure at least at one second redundancy brake pressure port in accordance with second redundancy braking signals that are provided by said electronic redundancy control unit;
said second redundancy pressure modulator having a second redundancy ventilation port for venting the second redundancy brake pressure; and,
said at least one second redundancy brake pressure port is connected to said second ventilation port such that the second redundancy brake pressure configured to be modulated, via a second ventilation path of said second brake pressure modulator, at said at least one second service brake pressure port.

7. The electronically controllable pneumatic brake system of claim 6, wherein said second brake pressure modulator has a second rapid ventilation valve at said second ventilation port for venting the at least one second service brake pressure.

8. The electronically controllable pneumatic brake system of claim 7, wherein said second rapid ventilation valve has a fourth rapid ventilation valve port connected to said second ventilation path, a fifth rapid ventilation valve port connected to surroundings, and a sixth rapid ventilation valve port connected to said at least one second redundancy brake pressure port.

9. The electronically controllable pneumatic brake system of claim 6, wherein said second brake pressure modulator has a second service brake relay valve; said second service brake relay valve has a second service brake relay valve reservoir port connected to a second reservoir port, a second service brake relay valve working port connected to said at least one second service brake pressure port, a second service brake relay valve control port configured to receive a second pilot control pressure, and a second service brake relay valve ventilation port which forms or is connected to said second ventilation port.

10. The electronically controllable pneumatic brake system of claim 8, wherein said second brake pressure modulator has a second service brake relay valve; said second service brake relay valve has a second service brake relay valve reservoir port connected to a second reservoir port, a second service brake relay valve working port connected to said at least one second service brake pressure port, a second service brake relay valve control port configured to receive a second pilot control pressure, and a second service brake relay valve ventilation port which forms or is connected to said second ventilation port; and, wherein said second service brake relay valve ventilation port is connected to said fourth rapid ventilation valve port.

11. The electronically controllable pneumatic brake system of claim 6, wherein at least one of said first brake pressure modulator and said second brake pressure modulator is of two-channel design.

12. The electronically controllable pneumatic brake system of claim 6, wherein:
said second brake pressure modulator is configured to modulate a third service brake pressure at least at one third service brake pressure port in accordance with third service braking signals that are provided by said electronic service brake control unit;
said second brake pressure modulator has a third ventilation port for venting the at least one third service brake pressure;
said second redundancy pressure modulator is configure to modulate a third redundancy brake pressure at least at one third redundancy brake pressure port in accordance with third redundancy braking signals provided by said electronic redundancy control unit;
said second redundancy ventilation port is configured to act so as to vent the third redundancy brake pressure; and, said third redundancy brake pressure port is connected to said third ventilation port such that the third redundancy brake pressure is configured to be modulated, via a third ventilation path of said second brake pressure modulator, at said at least one third service brake pressure port.

13. The electronically controllable pneumatic brake system of claim 12, wherein said second brake pressure modulator has a third rapid ventilation valve at said third ventilation port for venting the third service brake pressure.

14. The electronically controllable pneumatic brake system of claim 13, wherein said third rapid ventilation valve has a seventh rapid ventilation valve port connected to said third ventilation path, an eighth rapid ventilation valve port connected to surroundings, and a ninth rapid ventilation valve port connected to said at least one third redundancy brake pressure port.

15. The electronically controllable pneumatic brake system of claim 12, wherein said second brake pressure modulator has a third service brake relay valve, said third service brake relay valve has a third service brake relay valve reservoir port connected to a second reservoir port, a third service brake relay valve working port connected to said at least one third service brake pressure port, a third service brake relay valve control port configured to receive a third pilot control pressure, and a third service brake relay valve ventilation port which forms or is connected to said third ventilation port.

16. The electronically controllable pneumatic brake system of claim 14, wherein said second brake pressure modulator has a third service brake relay valve, said third service brake relay valve has a third service brake relay valve reservoir port connected to a second reservoir port, a third service brake relay valve working port connected to said at least one third service brake pressure port, a third service brake relay valve control port configured to receive a third pilot control pressure, and a third service brake relay valve ventilation port which forms or is connected to said third ventilation port; and, wherein said third service brake relay valve ventilation port is connected to said seventh rapid ventilation valve port.

17. The electronically controllable pneumatic brake system of claim 1 further comprising:
a trailer control valve having a trailer brake pressure port for providing a trailer brake pressure for a trailer, a trailer reservoir port for receiving reservoir pressure, and a trailer ventilation port for venting the trailer brake pressure; and,
wherein the trailer control valve a is connected to the electronic service brake control unit and receives trailer braking signals therefrom, and modulates the trailer brake pressure on a basis of said trailer braking signals.

18. The electronically controllable pneumatic brake system of claim 17, wherein:
said first redundancy pressure modulator or a second redundancy pressure modulator has a trailer redundancy brake pressure port for providing a trailer redundancy pressure; and,
said trailer redundancy brake pressure port is connected to said trailer ventilation port such that the trailer redundancy pressure is configured to be modulated, via a trailer ventilation path of said trailer control valve, at said trailer brake pressure port.

19. The electronically controllable pneumatic brake system of claim 1, wherein the electronic service brake control unit is connected to a first voltage source and said electronic redundancy control unit is connected to a second voltage source that is independent of said first voltage source.

20. The electronically controllable pneumatic brake system of claim 1, wherein the first compressed-air reservoir and the further compressed-air reservoir are independent of one another.

21. The electronically controllable pneumatic brake system of claim 1 further comprising:
an autonomous driving unit;
a vehicle bus; and,
said electronic service brake control unit and the electronic redundancy control unit being connected to said autonomous driving unit and being configured to receive braking demand signals from said autonomous driving unit via said vehicle bus or an alternative network communication.

22. The electronically controllable pneumatic brake system of claim 1, wherein the vehicle is a utility vehicle.

23. A vehicle comprising:
a front axle;
at least one rear axle;
an electronically controllable pneumatic brake system having an electronic service brake control unit, an electronic redundancy control unit, and a first brake pressure modulator;
said first brake pressure modulator being connected to a first compressed-air reservoir in order to receive reservoir pressure and configured to modulate a first service brake pressure at least at one first service brake pressure port in accordance with first service braking signals that are provided by said electronic service brake control unit;
said first brake pressure modulator having a first ventilation port for venting the first service brake pressure;
said first redundancy pressure modulator being connected to the first compressed-air reservoir or to a further compressed-air reservoir in order to receive reservoir pressure and configured to modulate a first redundancy brake pressure at least at one first redundancy brake pressure port in accordance with first redundancy braking signals provided by said electronic redundancy control unit;
said first redundancy pressure modulator having a first redundancy ventilation port for venting the first redundancy brake pressure; and,
said at least one first redundancy brake pressure port being connected to said first ventilation port such that the first redundancy brake pressure is configured to be modulated, via a first ventilation path of said first brake pressure modulator, at said at least one first service brake pressure port.

24. The vehicle of claim 23, wherein said first brake pressure modulator is assigned to said front axle and a second brake pressure modulator is assigned to said at least one rear axle.

25. The vehicle of claim 23, wherein the vehicle is a utility vehicle.
